(19) United States
(12) Patent Application Publication
(10) Pub. No.: US 2024/0254798 A1
(43) Pub. Date: Aug. 1, 2024

(54) SLIDE BEARING IN THE BUILDING TRADE

(71) Applicant: SCHREIBER BRUECKEN-DEHNTECHNIK GMBH, Mainhardt (DE)

(72) Inventor: Georg Christian SCHREIBER, Schwaebisch Hall (DE)

(21) Appl. No.: 17/261,600

(22) PCT Filed: Jul. 20, 2019
(86) PCT No.: PCT/EP2019/069714

§ 371 Date: Jul. 1, 2021

(30) Foreign Application Priority Data
Jul. 23, 2018 (DE) 10 2018 117 712.7

(51) Int. Cl. E04H 9/02; C10M 107/38; C10M 107/44; C10N 40/02; C10N 50/08

(52) U.S. Cl. CPC E04H 9/021; C10M 107/38; C10M 107/44; C10M 2213/0623; C10M 2217/0443; C10N 2040/02; C10N 2050/08

(57) ABSTRACT

The use of a sliding material, which consists of more than 60 wgt.-% PTFE, in a slide bearing for buildings, comprising two bearing elements, which are movably guided toward each other in the slide bearing within a relative motion region of the bearing elements, wherein a slide element made of the sliding material is fixed in position to a first of the two bearing elements and arranged between the bearing elements such that it is in sliding contact with the second of the two bearing elements within the entire relative motion region of the two bearing elements toward each other. In the case of implementation of the slide bearing for an area of application in which the bearing elements are subjected to a totalled slide path toward each other of more than 20,000 m at a pressing force against each other of more than MPa over the entire slide path, wherein the sliding material consists of 10 wgt.-% to 40 wgt.-% polyimide, particularly 15 wgt.-% to 25 wgt.-% polyimide, and the sliding material has such material properties that, in the case of a long-term sliding friction test carried out according to D.6.2 of the standard EN 1337-2:2004, solely with the variations that the long-term sliding friction test is carried out over a totalled slide path of more than 20,000 m and that a contact pressure for the sliding material of more than 60 MPa, particularly 90 MPa is applied, the requirements for the coefficients of friction thereof according to table 2 of the standard EN 1337-2:2004 are met.

### FIELD

The invention concerns the use of a sliding material in a sliding bearing for building structures and a sliding bearing for building structures and the use of such a sliding bearing in a building structure.

### BACKGROUND

A very large number of very different sliding materials are known in the state of the art for the implementation of sliding bearings for different purposes of use. Thus, it is known for example to use lubricant-impregnated sintered metals, graphite or plastics like for example polyamide, PTFE and UHMWPE as a sliding material for producing sliding bearings. The large number of known sliding materials is based on the large number of different areas of use, for example sliding bearings for mechanical engineering, in medical technology and in the construction industry. Each special area of application involves specific characteristic conditions to which a sliding bearing is exposed so that the sliding material to be used for a sliding bearing has to be selected in specifically targeted fashion in relation to the specific demands of the respective area of application. The invention in contrast relates to the specific area of application of using a sliding material in a sliding bearing in the construction industry. Such sliding materials must meet extremely high demands which are described in the standard EN 1337-2:2004. To describe the properties of the sliding material of the general kind set forth, to the use of which the present invention relates, and to describe the properties of the sliding material in a sliding bearing of the general kind set forth, to which the present invention relates, the content of the standard EN 1337-2:2004 is incorporated into the disclosure of the description of the present invention and is thus embraced thereby. Thus, for example essential characteristics of a sliding material of the general kind set forth are defined in points 4.1 and 6.6 of the stated standard, in particular in relation to Appendix D thereof, in which the test conditions for proving the specified properties are defined.

The above-mentioned standard lists the sliding material PTFE as the sole admissible sliding material. In actual fact it has been found in the past that PTFE is a sliding material which meets the demands described in the specified standard and which is suitable for use in sliding bearings of the general kind set forth in building structures, for example in bridge sliding bearings or high-rise sliding bearings to which the standard EN 1337 relates, and in earthquake sliding bearings which for earthquake-resistant building permit a horizontal movement of a building relative to the ground. It has however already long been noted that the properties of PTFE in that use as a sliding material in sliding bearings of the general kind set forth are not optimum in many aspects. For, both in regard to the load-bearing capacity and also in regard to wear the properties of PTFE do not satisfy the highest requirements, which besides high manufacturing costs involves a high degree of maintenance. In the use of the general kind set forth of the sliding material that can give rise to extremely high costs, for example in the case of the need for replacement of bridge sliding bearings at railroad or freeway bridges. With that background in mind there have already long been endeavors to develop a sliding material which complies with the demands of the specified standard and does not suffer from the disadvantages of PTFE. Thus, for example different possible ways of how the disadvantages of PTFE can be counteracted were already presented in the year 2001 at the conference “5th World Congress on Joints, Bearings and Seismic Systems for Concrete Structures” in Rome, for example by using PTFE which is enclosed in a UHMWPE ring. EP 1 523 598 A1 in contrast described for example the approach of using pure UHMWPE as the sliding material in sliding bearings of the general kind set forth, instead of PTFE. The document EP 3 117 050 B1 in contrast for example describes the approach of improving the properties of PTFE by adding PPVE. The document WO 2009/010487 A1 in contrast already proposed using as an alternative to PTFE a sliding material of polyamide in sliding bearings of the general kind stated. In addition, it is known for example to improve the properties of PTFE by adding carbon or glass fibers. While a PTFE modified in that way is basically permitted in the USA as the sliding material (see AASHTO LRFD Bridge Design Specifications) such additives in PTFE for the production of a sliding material are not allowed in Europe in accordance with the stated standard. In spite of the many different endeavors which have been made in the past to provide a sliding material which satisfies the requirements in accordance with the stated standard and which however does not suffer from the described disadvantages of PTFE hitherto no sliding material for use in a sliding bearing of the general kind set forth, that has such properties, has been found.

### SUMMARY

Therefore, the object of the invention is to at least partially overcome the problems which occur in the use of the general kind set forth of sliding materials in sliding bearings and/or to provide a sliding bearing which at least partially overcomes the described problems of the sliding bearing of the general kind set forth.

As a way of attaining the object of the invention the invention proposes the use of a sliding material. According to the invention the sliding material comprises at least 60 wt-% of PTFE, in particular between 60 wt-% and 90 wt-% of PTFE. In that respect the invention relates to the use of a sliding material in the sliding bearing for building structures, which includes two bearing elements which are guided moveably relative to each other in the sliding bearing within a relative movement region of the bearing elements, wherein a sliding element comprising the sliding material is fixed in position at a first of the two bearing elements and is arranged between the bearing elements in such a way that within the total relative movement region of the two bearing elements relative to each other it is in sliding contact with the second of the two bearing elements. The two bearing elements are thus spaced from each other in a vertical direction by the sliding element and respectively bear against the sliding element. The first bearing element bears against the sliding element and is secured in a fixed position relative thereto, the second bearing element bears against the sliding element with its side which is towards the sliding element and which is thus in the form of the sliding side of the second bearing element. Sliding displacability of the two bearing elements relative to each other in the total relative movement region of the bearing elements with respect to each other is made possible by way of the sliding contact between the sliding element and the sliding side of the second bearing element. Preferably the sliding element is horizontally peripherally enclosed by the first bearing element and bears with a first vertical side on the first bearing element, wherein the second bearing element bears against the sliding element at the second vertical side of the sliding element which is opposite to the first bearing element.

Preferably the sliding element rests uninterruptedly over its surface on the first bearing element and is uninterruptedly encircled by the first bearing element, and preferably the first bearing element lies with its portion which encircles the sliding element peripherally around the sliding element on the sliding element. The sliding element is therefore preferably enclosed in the first bearing element, whereby the sliding element is prevented from horizontally spreading under a high pressing pressure. Preferably the bearing element is made from a steel and preferably the second bearing element is made from a stainless steel. Preferably the sliding element comprises a first and a second vertical portion which are both formed in one piece by the sliding material, wherein the first vertical portion is encircled over its vertical extent by the first bearing element and the sliding element projects with the second vertical portion vertically above the first bearing element so that the first bearing element does not extend horizontally beside the second vertical portion of the sliding element, wherein preferably the first vertical portion has a vertical extent between 2 mm and 6 mm, preferably between 3 mm and 5 mm, and the second vertical portion has a vertical extent between 3 mm and 8 mm, preferably between 4 mm and 6 mm.

Preferably the sliding element is horizontally peripherally encircled over at least 30%, but preferably at least 50%, of its vertical extent, by the first bearing element. In particular the sliding element projects vertically above the first bearing element over at least 10%, in particular at least 30%, of its vertical extent, or the second bearing element and the first bearing element overlap vertically within the horizontal extent of the sliding element, for example by the first bearing element extending vertically along the second bearing element with a horizontal portion which encloses the sliding element, without being in vertical contact with the second bearing element. In that respect it is generally advantageous that the sliding element on the one hand is sufficiently enclosed in the first bearing element and on the other hand a sufficient vertical spacing between the bearing elements is ensured, so that upon a relative movement of the bearing elements with respect to each other they do not rub directly against each other but only the second bearing element slides along the sliding element.

The geometrical configuration of such bearings is sufficiently known to the man skilled in the art, usual configurations are set forth for example in the document WO 2012/114246 A1 or in WO 2009/010487 A1 or in the standard EN 1337-7:2018 or in the above-mentioned conference presentation of 2001, in which respect in relation to the various possible geometrical configurations of sliding bearings, in particular their bearing elements and the sliding element, the disclosure of the above-specified documents is incorporated into the disclosure of the description of the present invention. As can also be seen from the above-mentioned documents for example sliding bearings with sliding elements are known, whose side that faces towards the sliding side of the second bearing element is flat or curved, wherein the sliding side is of a configuration corresponding to that side of the sliding element. In addition bearings with an elastomer element are also known, the element being arranged on one of the bearing elements. The use according to the invention concerns the implementation of the sliding bearing for an area of application in which the bearing elements are exposed to a total overall sliding travel relative to each other of over 20,000 m, in particular over 50,000 m, in particular over 70,000 m, in particular over 80,000 m at a pressing pressure against each other of over 50 MPa, in particular over 100 MPa, in particular over 150 MPa, in particular over 180 MPa over the total sliding travel, wherein according to the invention the sliding material comprises 10 wt-% to 40 wt-% of polyimide, in particular 15 wt-% to 25 wt-% of polyimide, and wherein the sliding material has such material properties that in a long-term sliding friction test which is carried out in accordance with point D.6.2 of the standard EN 1337-2:2004 with exclusively the modifications that the long-term sliding friction test is carried out over a totalled overall sliding travel of over 20,000 m, in particular over 50,000 m, in particular of 50,154 m, in particular over 70,000 m, in particular over 80,000 m, and that a contact pressure is applied to the sliding material of over 60 MPa, in particular 90 MPa, it complies with the requirements on its coefficients of friction in accordance with Table 2 of the standard EN 1337-2:2004. In addition the sliding material also meets the requirements set forth in the specified standard for its coefficients of friction in a long-term sliding friction test in accordance with D.6.2 of the standard and it generally preferably meets the requirements throughout over the totalled overall sliding travel. In that respect self-evidently the long-term sliding friction test is carried out continuously over the entire sliding travel and is thus performed uninterruptedly in accordance with the standard so that no interruption in the sliding friction test, which is not provided for in the standard, occurs over the total sliding travel. The invention is therefore based on the realization that the use of a sliding material which comprises over 60 wt-% of PTFE and 10 wt-% to 40 wt-% of polyimide, in particular 15 wt-% to 25 wt-% of polyimide, makes it possible to provide a sliding bearing which can withstand extreme loadings which can typically occur in use in building structures, and the sliding material has only very slight wear. In that respect the inventors realised that the properties of the sliding material, that are relevant for the requirements in sliding bearings for the construction industry, in a proportion of 15% to 25% of polyimide and 75% to 85% of PTFE in the sliding material are particularly advantageous, in particular in relation to the possibly totaled overall sliding travel with a high contact pressure. The invention therefore permits on the one hand the implementation of a sliding bearing which is maintenance-free over an extremely long time as it is suitable for an area of application in which the bearing elements cover a totalled overall sliding travel distance relative to each other of over 20,000 m, in particular over 50,000 m, in particular over 70,000 m, in particular over 80,000 m. The overall sliding travel of the two sliding elements in the sliding bearing relative to each other is defined by way of the addition of the movements of the bearing elements in the sliding bearing relative to each other when the sliding bearing is installed in the building and in that connection the sliding elements exert a pressing pressure against each other of over 50 MPa while they slide against each other in the sliding bearing. The suitability thus relates to the fact that, even after a totalled sliding travel of over 20,000 m, in particular over 50,000 m, in particular over 70,000 m, in particular over 80,000 m of the two sliding elements relative to each other, the sliding bearing fulfils its required sliding bearing property without needing to be maintained, in particular without the sliding element having to be replaced. Particularly preferably the sliding material has such material properties that the vertical extent of the sliding material after a total overall sliding travel of 50,154 m with a loading on the sliding material in accordance with the above-mentioned long-term test according to the standard 1337-2:2004 with the sole modification that a contact pressure of 60 MPa is applied to the sliding material, is more than 30%, in particular more than 40% of the original vertical extent of the sliding material, that is to say immediately prior to the beginning of the long-term test. The vertical extent in that respect is the extent in the direction in which the pressing pressure acts during the long-term test. As upon use in a sliding bearing the sliding material is usually pressed vertically between the bearing elements and holds the bearing elements spaced vertically from each other and its vertical extent is in the mm range, in particular 5-30 mm, accordingly upon use of the sliding material in a sliding bearing the sliding bearing retains its properties which are purposefully required even after a corresponding long overall sliding travel as a vertical change in height of the sliding bearing by a few mm does not have any influence on its intended suitability. It has been found to be particularly advantageous, when using the sliding material in a sliding bearing, for the vertical extent of the sliding material to be between 5 mm and 15 mm, in particular between 6 mm and 10 mm, in particular being 8 mm. Correspondingly then the sliding element which is used in the sliding bearing and which is produced from the sliding material and thus comprises the sliding material is of a vertical extent, that is to say a vertical thickness, which is between 5 mm and 15 mm, preferably between 6 mm and 10 mm, preferably 8 mm. It has proven to be particularly advantageous for the sliding element to be produced from the sliding material by the sliding material being produced directly of the thickness intended for the sliding element or for its situation of use, in which case either the sliding material is already produced directly in the geometrical shape intended for the sliding element in production of the sliding material or the sliding material is firstly produced in the form of a plate of the appropriate vertical thickness, from which the sliding element is then shaped, for example by cutting, grinding and so forth. Production of the sliding material directly of the thickness intended for its use of 5 mm to 15 mm, preferably 6 mm to 10 mm, preferably 8 mm, has proven to be particularly advantageous as in that way particularly preferably it is possible to produce a sliding material having the properties described for its use according to the invention as then the sliding material, in the production thereof, by virtue of the vertical thickness in the corresponding region, can possibly be sintered completely and uniformly therethrough and nonetheless is of a sufficient thickness to be suitable for the described use. Preferably production of the sliding material is effected by a procedure whereby in a first working step a PTFE powder and a polyimide powder are mixed with the specified percentage proportions until a homogenous mixture of the powders is attained, whereafter then that homogenous powder mixture is pressed and sintered. Preferably it is only after the sintering operation that the lubrication pockets which are mandatorily provided in the described standard are impressed on to the sliding material so that it can be used as a sliding element in a sliding bearing as described. In addition the use according to the invention makes it possible to produce sliding bearings of small dimensions. In that way on the one hand the sliding bearing production costs can be reduced while on the other hand installation of the sliding bearings in building structures can be simplified. The background is that, by virtue of the properties of the sliding material used, the two bearing elements can be exposed to an extremely high pressing pressure against each other and thus the sliding element can be exposed to a very high pressing pressure between the sliding bearings without excessive friction occurring between the sliding element and the second bearing element and without the sliding element wearing excessively. The invention is thus based on the specifically targeted selection of the addition of polyimide to PTFE in the specified percentage range, wherein the inventors by performing extensive long-term and high-loading sliding friction tests established that, with the described selection of the material of the sliding material, the described properties of the sliding material are attained and use of the sliding material permits production of a sliding bearing having the specified properties. It has proven to be particularly preferable for the sliding material to be produced in such a way that it consists to over 95%, in particular over 99%, exclusively of PTFE and polyimide. For, the inventors realised that it is precisely the material combination of PTFE and polyimide, in particular in the specified percentage range, wherein in particular the relationship of PTFE to polyimide is between 3/2 and 9/1, in particular between 3/1 and 6/1, that is particularly advantageous for the use of the sliding material for producing the described sliding bearing.

In an embodiment the sliding material has such material properties that in a long-term sliding friction test which is carried out in accordance with point D.6.2 of the standard EN 1337-2:2004 with exclusively the modifications that the long-term sliding friction test is carried out over a totalled overall sliding travel of over 20,000 m, in particular over 50,000 m, in particular of 50,154 m, in particular over 70,000 m, in particular over 80,000 m, and that a contact pressure is applied to the sliding material of over 60 MPa and a mean sliding speed over the totalled overall sliding travel of 0.4 mm/s is involved, it fulfils the requirements on its coefficients of friction in accordance with Table 2 of the standard EN 1337-2:2004. In that respect it is to be noted that in the long-term sliding friction test in accordance with D.6.2 of the standard EN 1337-2:2004 it is provided that a sliding speed of 0.4 mm/s is applied only in short measurement intervals of 22 m whereas a sliding speed of 2 mm/s is applied in longitudinal extent intervals of 1,000 m. The inventors realized that, for durability of a sliding material in a sliding bearing and thus for the implementation of a sliding bearing with a sliding material which withstands particularly high demands and is particularly maintenance-free the sliding element produced from the sliding material is not to wear even when, over a long totalled overall sliding travel at a low sliding speed of the bearing elements relative to each other the sliding material retains its properties which are relevant for the sliding bearing without wearing excessively. The inventors correspondingly realized that it is particularly advantageous for the use of a particularly advantageous sliding bearing to use a sliding material which still meets the requirements of the standard EN 1137-2: 2004 even when, in a long-term sliding friction test, it experiences an ongoing mean sliding speed of 0.4 mm/s relative to its counterpart surface and that such a sliding material can be produced by the described mixing of PTFE with polyimide. In an embodiment the sliding material has such material properties that in a long-term sliding friction test which is carried out in accordance with D.6.2 of the standard EN 1337-2:2004 with exclusively the modifications specified hereinbefore in the embodiments according to the invention, it meets the requirements for its coefficients of friction, required in the specified standard for the long-term test at a bearing temperature of −35° C., even when instead of a bearing temperature of −35° C., the bearing temperature is −50° C. and the coefficients of friction are ascertained at that bearing temperature of −50° C. It will be appreciated that in that case the sliding material as described hereinbefore meets the standard requirements, even with the above-specified modifications, and also meets the requirements for its coefficient of friction as required in the standard at −35° C.

In an embodiment the sliding material has a characteristic value in respect of its pressure strength in accordance with Table 10 of the standard in EN 1337-2:2004. of over 150 MPa, in particular at least 180 MPa. By virtue thereof the use can permit the implementation of a sliding bearing which even in the event of singularly occurring extremely high pressure loadings remains destruction-free, which is particularly advantageous for example for using sliding bearings in bridge construction as extremely high loadings can act on such sliding bearings at singular peak times.

The invention further concerns a sliding bearing for building structures for an area of application in which bearing elements of the sliding bearing are exposed to a totalled overall sliding travel relative to each other of over 20,000 m, in particular over 50,000 m, in particular over 70,000 m, in particular over 80,000 m, with a pressing pressure against each other of over 50 MPa, in particular over 100 MPa, in particular over 150 MPa, in particular at least 180 MPa, over the overall sliding travel, that is to say over the entire totalled overall sliding travel between the bearing elements. The bearing according to the invention includes two bearing elements which are guided moveably relative to each other in the sliding bearing within a relative movement region of the bearing element, wherein arranged between the bearing elements is a sliding element comprising a sliding material, which is secured in a fixed position to a first of the two bearing elements and is in sliding contact with the second of the two bearing elements within the overall relative movement region of the bearing elements relative to each other, wherein the sliding material comprises at least 60 wt-% of PTFE. In relation to further possible design configurations of the sliding bearing attention is directed to the foregoing description, in particular in relation to the sliding bearings of the general kind set forth. In the sliding bearing according to the invention the sliding material comprises 10 wt-% to 40 wt-% of polyimide, in particular 15 wt-% to 25 wt-% of polyimide. The sliding material has such material properties that in a long-term sliding friction test which is carried out in accordance with point D.6.2 of the standard EN 1337-2:2004 with exclusively the modifications that the long-term sliding friction test is carried out over a totalled overall sliding travel of over 20,000 m, in particular over 50,000 m, in particular of 50,154 m, in particular over 70,000 m, in particular over 80,000 m, and that a contact pressure is applied to the sliding material of at least 60 MPa it meets the requirements for its coefficients of friction in accordance with Table 2 of the standard EN 1337-2:2004. The sliding material and the sliding bearing can have further properties which are described hereinbefore in connection with the use according to the invention.

In an embodiment the sliding bearing has a minimum operative bearing temperature of −50° C. or less and a maximum operative bearing temperature of 80° C. or more. The described embodiment has been found to be particularly advantageous as even with extreme temperature fluctuations which can temporarily occur depending on the respective kind of use the sliding bearing according to the invention of this embodiment does not experience any damage. The man skilled in the art interprets the terms minimum and maximum operative bearing temperature as meaning the temperature to which the sliding bearing can be exposed over a short time, in particular a time of 8 hours, without the sliding bearing experiencing damage, that is to say a sliding bearing which was exposed to such a temperature can be used in a building structure and in that case has its above-discussed properties. In an embodiment the sliding bearing according to the invention is of such a design that it can have its minimum or maximum operative bearing temperature over a time of 8 hours while its sliding element is exposed to a vertical pressing pressure of 150 MPa without suffering damage. In general it is to be indicated at this juncture that the material of the sliding material is always crucial for the resistance of the sliding bearing, in particular in relation to wear, compression strength and temperature resistance. It is sufficiently known in the state of the art for the bearing elements to be produced from austenitic steel or hard chrome in such a way that they readily meet the requirements made on the sliding bearings. The element of the sliding bearing, that is relevant for the durability or load-bearing capability or resistance of the sliding bearing is always the sliding element. Accordingly the inventors realized that by the specifically targeted selection of the sliding material of the sliding element, which is described herein, it is possible to provide a sliding bearing having the above-discussed particular properties.

In an embodiment the second bearing element at its side towards the sliding element, that is to say at its sliding side, is made from austenitic steel or hard chrome and in any intended operating position bears with its sliding side in surface contact against the sliding element. Particularly preferably the two bearing elements in an intended operating position are spaced from each other vertically by the sliding element, wherein both bearing elements and the sliding element respectively are of a horizontal cross-section of over 50 cm², in particular between 50 cm² and 100,000 cm², and wherein the sliding element has a vertical extent of at least 5 mm, in particular between 5 mm and 30 mm, in particular between 5 mm and 15 mm, in particular between 6 mm and 10 mm, in particular being 8 mm. Particularly preferably the vertical extent of the sliding element after a totalled overall sliding travel of 50,154 m with a loading on the sliding element in the sliding bearing as in accordance with the above-mentioned long-term test of the standard 1337-2:2004 with the sole modification that a contact pressure of 60 MPa is applied to the sliding element is more than 30%, in particular more than 40% of the original vertical extent of the sliding element, that is to say before the beginning of the overall sliding travel. In an embodiment the two bearing elements are guided horizontally moveably relative to each other, the bearing elements being guided tiltably about at least a horizontal direction. Particularly preferably the bearing elements are tiltable relative to each other about a plurality of directions which are disposed horizontally and thus perpendicularly to the vertical, being rotated in the horizontal plane through angles relative to each other. Particularly preferably the two bearing elements are guided relative to each other by way of a guide arrangement in the form of a portion of a sphere or at least one of the bearing elements is supported in the sliding bearing at an elastomer element so that they are guided tiltably relative to each other about a plurality of and in particular any horizontal direction. Preferably the sliding element in the sliding bearing is horizontally peripherally encircled by the first bearing element and bears in particular with a first vertical side against the first bearing element, wherein the second bearing element bears against the sliding element at the vertical side of the sliding element, that is opposite the first bearing element. Preferably the sliding element bears in surface contact uninterruptedly against the first bearing element. Preferably the sliding element is horizontally peripherally encircled over at least 30% of its vertical extent by the first bearing element and is thus enclosed therein. Preferably the sliding element further projects vertically above the first bearing element, or the second bearing element and the first bearing element overlap vertically within the horizontal extent of the sliding element. The invention also further concerns the use of a sliding material as described hereinbefore for the production of a sliding bearing as described hereinbefore, wherein attention is directed to the respective above-described embodiment of the sliding material and the sliding bearing.

The invention further concerns the use of a sliding bearing according to the invention in a building structure, wherein the sliding bearing is installed in the structure and is exposed in the structure to a pressing force which exerts a pressing pressure on the sliding element, to which it is exposed between the two bearing elements, that is in an ongoing fashion over 50 MPa, in particular over 100 MPa, in particular over 150 MPa. In that respect the expression pressing pressure acting in an ongoing fashion on the sliding element is used to mean the pressing pressure which ensues from the static calculations forming the basis for use of the sliding bearing in the structure, as the mean pressing pressure to be expected when the sliding bearing is installed in the structure. As described hereinbefore the inventors realized that use of the sliding bearing in a building structure under continuously extremely high pressures is made possible by the specific selection of the sliding material which is used for the sliding element of the sliding bearing, without the sliding element suffering from major wear phenomena. As described hereinbefore this makes it possible to save on maintenance costs and to save on production costs in manufacture of the sliding bearing and in production of the building structure. Particularly preferably in the use according to the invention the sliding bearing remains installed in the building structure until the second bearing element has covered along the sliding element a sliding travel of over 20 km, in particular over 30 km, in particular over 50 km, in particular over 70 km, in particular over 80 km. As the first bearing element in the sliding bearing is connected in a fixed position to the sliding element the above-mentioned sliding travel corresponds to the totalled overall sliding travel of the two bearing elements relative to each other in the described embodiment of the use according to the invention.

Correspondingly the invention further concerns a building structure in which the sliding bearing according to the invention is installed, wherein one of the two bearing elements of the sliding bearing is fixed to a ground element of the building which is fixed to the ground and the other of the two bearing elements is fixed to a support element of the building. The support element in that case is an element of the building which carries a functional element thereof, for example in the case of a bridge construction the superstructure or in the case of a high-rise building side walls or in the case of a hall structure the roof. The ground element can be for example a bridge pillar or a foundation element or a roof support element connected to the ground.

### BRIEF DESCRIPTION OF THE DRAWINGS

The invention is described in greater detail hereinafter by means of two embodiments by way of example with reference to two Figures in which:

FIG. 1 shows a first embodiment of a sliding bearing according to the invention, and

FIG. 2 shows a second embodiment of a sliding bearing according to the invention.

### DETAILED DESCRIPTION

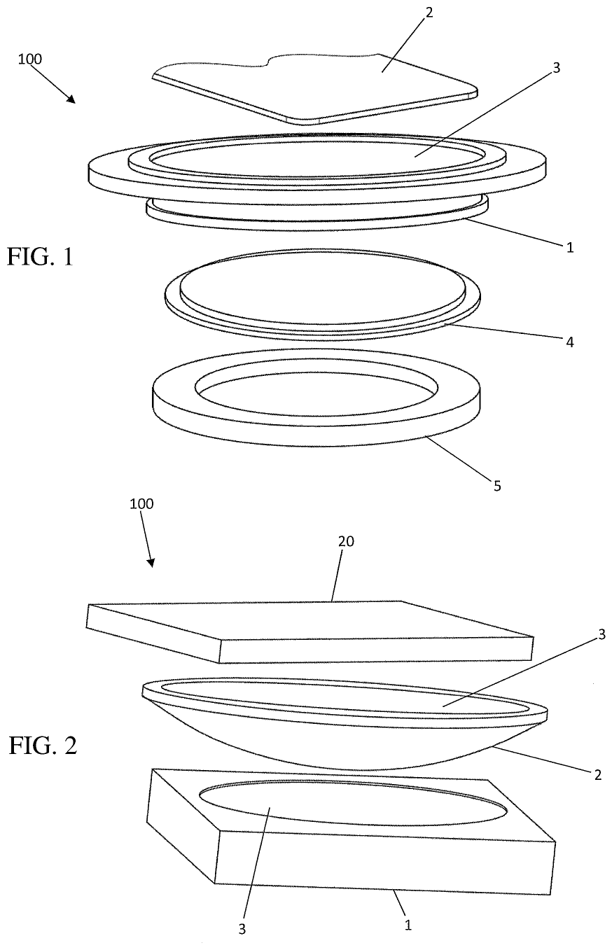

FIG. 1 is a diagrammatic exploded view of some elements of a sliding bearing 100 according to the invention in simplified form. Further elements which are usual in sliding bearings like for example fixing elements are not shown here for the sake of clarity in FIG. 1 and also subsequently in FIG. 2. The sliding bearing 100 shown in FIG. 1 has a pot 5 made from steel. Fitted vertically on to the pot 5 is an elastomer element 4. The elastomer element 4 can elastically deform by virtue of the corresponding configuration of the elastomer element 4 and the pot 5. The sliding bearing 100 further includes a cover of steel, on which a flat sliding element 3 is arranged. The sliding element 3 is fixed in position on the cover, acting as a first bearing element 1 of the sliding bearing 100. The sliding bearing 100 further has a second bearing element 2 which is in the form of a sliding plate of austenitic steel and is fixed to an anchor plate. In any intended operating position of the sliding bearing 100 the second bearing element 2 bears with its sliding side against the sliding element 3 and can slide along that sliding element 3 within a relative movement region of the bearing elements 1, 2 relative to each other, that movement region being established by the geometrical configuration of the sliding bearing 100.

The sliding bearing 100 shown in FIG. 1 therefore has only one sliding element 3 which is in the form of a flat sliding element and is of a circular disc configuration. It will be appreciated that disc-like sliding elements of a polygonal cross-section, in particular a rectangular or square cross-section, are also known. The sliding element 3 is horizontally surrounded by a ring formed by the first bearing element 1 and is thus enclosed in the first bearing element 1. In the sliding bearing 100 the two bearing elements 1, 2 are guided moveably relative to each other within a relative movement region which is established by the guidance afforded by the first bearing element 1 in the form of a cover and the second bearing element 2 in the sliding bearing 100. In the described structure the elastomer element 4 serves to ensure tiltability of the two bearing elements 1, 2 relative to each other about any horizontal direction. The first bearing element 1 is fixed in position to the elastomer element 4, but by virtue of the elastomer element 4 can perform pivotal movements relative to the pot 5. The sliding bearing 100 in FIG. 2 has two different sliding elements 3.

The sliding bearing 100 in FIG. 2 has a first bearing element 1 which is in the form of a lower bearing portion and to which a curved sliding element 3 is fixed in position. In this arrangement the curved sliding element 3 is enclosed over its entire vertical extent in the first bearing element 1. The second bearing element 2 is in the form of a hard-chromed cap or dome and bears with its sliding side against the curved sliding element 3. The second bearing element 2 is pivotable with respect to the first bearing element 1 about any horizontal directions, wherein upon the pivotal movement the second bearing element 2 slides with its sliding side along the sliding element 3 and the cap or dome shape of the second bearing element 2 is of a corresponding configuration with the curved surface of the sliding element 3, that is towards the second bearing element 2. A second sliding element 3 is arranged at the second bearing element 2 and is connected thereto in a fixed position, which is in the form of a flat sliding element 3 and is of an annular disc-like configuration and is enclosed in the second bearing element 2. The sliding bearing 100 further has a third bearing element 20 which is in the form of a sliding plate of austenitic steel and is fixed to a sliding plate member. In the sliding bearing 100 the third bearing element 20 in any regular operating position bears with its sliding side against the flat sliding element 3 fixed to the second bearing element 2. The third bearing element 20 can thus slide within its relative movement region with respect to the second bearing element 2 along the flat bearing element 3.

Accordingly there is a first bearing element pairing comprising the first bearing element 1 and the second bearing element 2 and a second bearing element pairing comprising the second bearing element 2 and the third bearing element 3, wherein provided between the bearing elements of each pairing is a respective sliding element comprising a sliding material so that the bearing elements of the respective pairing can slide along each other with as little friction as possible. The provision of two bearing element pairings, wherein a respective sliding element comprising a sliding material is provided between the bearing elements of each pairing and the sliding elements are spaced vertically from each other by at least one of the bearing elements, is generally advantageous in a sliding bearing according to the invention. In that respect one of the bearing elements can be part of both bearing element pairings so that the two bearing element pairings are formed by three bearing elements, or there can be provided four bearing elements, wherein two of the four bearing elements respectively form one of the bearing element pairings.

In the described embodiments the inventors carried out tests with sliding elements comprising different sliding materials. In an embodiment according to the invention of the two structures shown in FIGS. 1 and 2, a sliding material was used, which comprises 80% of PTFE and 20% of polyimide. In long-term tests the inventors found that that sliding material has such material properties that in a long-term sliding friction test which is carried out in accordance with D.6.2 of the standard EN 1337-2:2004 it meets the requirements in terms of its coefficients of friction in accordance with Table 2 of that standard. The inventors also realized that the sliding material has such material properties that it still meets the requirements of its coefficients of friction in accordance with Table 2 of the standard even when the described long-term sliding friction test, starting from what is described in that standard, is modified exclusively in that the long-term sliding friction test is carried out over a totalled overall sliding travel of 50,154 m, a contact pressure for the sliding material of 100 MPa is applied, and a mean sliding speed over the entire totalled sliding travel of 0.4 mm/s is involved. The inventors further established in long-term tests that the sliding material meets the requirements specified in respect of its coefficients of friction in accordance with Table 2 of the standard even when the long-term sliding friction test is effected in accordance with the specified standard, but modified exclusively in that it is carried out over a totalled overall sliding travel of 50,154 m, a contact pressure of 100 MPa is applied and a mean sliding speed over the totalled overall sliding travel of 2 mm/s is used. The provision of a suitable sliding material in a sliding bearing according to the invention is generally particularly advantageous. For, the use of such a sliding material in a sliding bearing according to the invention makes it possible to implement a sliding bearing which has extremely low wear phenomena in fast and also slow relative movements of the bearing elements relative to each other. The inventors also recognized that the described sliding material has a characteristic compression strength of 180 MPa and that the sliding bearing 100 produced has a minimum operative bearing temperature of −50° C. and a maximum operative bearing temperature of 100° C.

In another embodiment according to the invention of the sliding bearings shown in FIGS. 1 and 2 the inventors used a sliding material which comprises 25% polyimide and 75% PTFE. This sliding material also has such material properties that it meets the requirements on its coefficients of friction in accordance with the specified standard, even with the described modification according to the invention in the specified long-term sliding friction tests, to the effect that the overall greater totalled sliding travel than in accordance with the standard is required and the specified higher contact pressure than the contact required in accordance with the standard of 30 MPa is applied. In comparison with the sliding material which comprises 20% polyimide and 80% PTFE the material even has a higher characteristic compression strength and a similar temperature resistance but a higher level of wear so that a lower totalled overall sliding travel than in the case of the first-described sliding material could be achieved.

In another embodiment the sliding material used was a material which comprises 85% PTFE and 15% polyimide. That sliding material in respect of its properties in a long-term sliding friction test was very substantially comparable to the sliding material which comprises 25% polyimide and 75% PTFE, but it had a lower characteristic compression strength. With further alterations, specifically when using material compositions of the sliding material according to the invention involving 40% polyimide to 60% PTFE and 10% polyimide to 90% PTFE it was possible to find a further degradation in the properties of the sliding material according to the invention, wherein moreover in embodiments by way of example additives like for example glass fibers were also added, while maintaining the ratio of PTFE to polyimide, in which case in the embodiments by way of example the sliding material always consisted of at least 95% of the materials PTFE and polyimide. In that respect the composition of 15% to 25% polyimide and 15% to 85% PTFE was found to be particularly advantageous, that of 20% polyimide and 80% PTFE was found to be extremely advantageous.

### LIST OF REFERENCES

1 first bearing element
2 second bearing element
3 sliding element
4 elastomer element
5 pot
20 third bearing element
100 sliding bearing

What is claimed is:

1-13. (canceled)

14. Use of a sliding material which comprises at least 60 wt-% of PTFE in a sliding bearing for building structures, which includes two bearing elements which are guided moveably relative to each other in the sliding bearing within a relative movement region of the bearing elements, wherein a sliding element of the sliding material is secured in a fixed position to a first of the two bearing elements and is arranged between the bearing elements such that within the total relative movement region of the two bearing elements relative to each other it is in sliding contact with the second of the two bearing elements, comprising:
the implemention of the sliding bearing for an area of application in which the bearing elements are exposed to a totalled overall sliding travel relative to each other of over 20,000 m with a pressing pressure against each other of over 50 MPa over the entire sliding travel, wherein the sliding material comprises 10 wt-%-40 wt-% of polyimide, in particular 15 wt-%-25 wt-% of polyimide, and the sliding material has such material properties that in a long-term sliding friction test which is carried out in accordance with D.6.2 of the standard EN 1337-2: 2004 with exclusively the modifications that the long-term sliding friction test is carried out over a totalled overall sliding travel of over 20,000 m, in particular over 70,000 m and that a contact pressure for the sliding material of over 60 MPa, in particular 90 MPa is applied, it meets the requirements on its coefficients of friction in accordance with Table 2 of the standard EN 1337-2:2004.

15. The use according to claim 14, wherein the sliding material has such material properties that in a long-term sliding friction test which is carried out in accordance with D.6.2 of the standard EN 1337-2: 2004 with exclusively the modifications that the long-term sliding friction test is carried out over a totalled overall sliding travel of over 20,000 m, in particular over 70,000 m and that a contact pressure for the sliding material of over 60 MPa, in particular 90 MPa is applied and a mean sliding speed over the totalled overall sliding travel of 0.4 mm/s is involved, it meets the requirements on its coefficients of friction in accordance with Table 2 of the standard EN 1337-2:2004.

16. The use according to claim 14, wherein the sliding material has a characteristic value of its compression strength in accordance with Table 10 of the standard EN 1337-2:2004 of over 150 MPa, in particular at least 180 MPa.

17. A sliding bearing for building structures for an area of application in which bearing elements of the sliding bearing are exposed to a totalled overall sliding travel relative to each other of over 20,000 m, in particular over 70,000 m, at a pressing pressure against each other of over 50 MPa over the entire sliding travel, the sliding bearing including two bearing elements which are guided moveably relative to each other in the sliding bearing within a relative movement region of the bearing elements relative to each other, wherein arranged between the bearing elements is a sliding element comprising a sliding material which is fixed in position to a first of the two bearing elements and within the overall relative movement region of the bearing elements relative to each other is in sliding contact with the second of the two bearing elements, wherein the sliding material comprises at least 60 wt-% of PTFE, wherein:
the sliding material comprises 10 wt-%-40 wt-% of polyimide, in particular 15 wt-%-25 wt-% of polyimide, and the sliding material has such material properties that in a long-term sliding friction test which is carried out in accordance with D.6.2 of the standard EN 1337-2: 2004 with exclusively the modifications that the long-term sliding friction test is carried out over a totalled overall sliding travel of over 20,000 m, in particular over 70,000 m and that a contact pressure for the sliding material of at least 60 MPa, in particular 90 MPa is applied, it meets the requirements on its coefficients of friction in accordance with Table 2 of the standard EN 1337-2:2004.

18. The sliding bearing according to claim 17, wherein the sliding material has such material properties that in a long-term sliding friction test which is carried out in accordance with D.6.2 of the standard EN 1337-2: 2004 with exclusively the modifications that the long-term sliding friction test is carried out over a totalled overall sliding travel of over 20,000 m, in particular over 70,000 m and that a contact pressure for the sliding material of at least 60 MPa, in particular 90 MPa is applied and a mean sliding speed over the totalled overall sliding travel of 0.4 mm/s is involved, it meets the requirements on its coefficients of friction in accordance with Table 2 of the standard EN 1337-2:2004.

19. The sliding bearing according to claim 17, wherein the sliding material has a characteristic value of its compression strength in accordance with Table 10 of the standard EN 1337-2:2004 of over 150 MPa, in particular at least 180 MPa.

20. The sliding bearing according to claim 17, wherein the sliding bearing has a minimum operative bearing temperature of −50° C. or less and a maximum operative bearing temperature of 80° C. or more.

21. The sliding bearing according to claim 17, wherein the second bearing element at its side towards the sliding element is made from austenitic steel or hard chromium and in any regular operating position bears in surface contact against the sliding element.

22. The sliding bearing according to claim 17, wherein the two bearing elements in a regular operating position are vertically spaced from each other by the sliding element, wherein both bearing elements and the sliding element respectively are of a horizontal cross-section of over 50 cm² and wherein the sliding element has a vertical extent of at least 5 mm, in particular between 5 mm and 30 mm.

23. The sliding bearing according to claim 22, wherein the bearing elements are guided moveably relative to each other horizontally and the bearing elements are guided tiltably relative to each other about at least one horizontal direction.

24. The sliding bearing according to claim 17, wherein the sliding material is horizontally peripherally enclosed by the first bearing element.

25. Use of the sliding bearing according to claim 17, wherein the sliding bearing is installed in a building structure and in the building structure is exposed to a pressing force which exerts a pressing pressure on the sliding element, to which it is exposed between the two bearing elements, which is persistently over 50 MPa.

26. The use according to claim 25, wherein the sliding bearing remains installed in the building structure until the second bearing element has covered along the sliding element a sliding travel of over 20 km, in particular over 50 km, in particular over 70 km.
